(19) United States
(12) Patent Application Publication
(10) Pub. No.: US 2019/0086208 A1
(43) Pub. Date: Mar. 21, 2019

(54) ROTATIONAL SPEED SENSOR AND OPERATION OF A ROTATIONAL SPEED SENSOR AT VARIOUS FREQUENCIES AND IN VARIOUS DIRECTIONS

(71) Applicant: Robert Bosch GmbH, Stuttgart (DE)

(72) Inventors: Andreas Lassl, Ditzingen (DE); Burkhard Kuhlmann, Reutlingen (DE); Thorsten Balslink, Kirchentellinsfurt (DE)

(73) Assignees: Robert Bosch GmbH, Stuttgart (DE); Robert Bosch GmbH, Stuttgart (DE)

(21) Appl. No.: 15/743,002

(22) PCT Filed: May 24, 2016
(86) PCT No.: PCT/EP2016/061713

§ 371 Date: Jan. 9, 2018

(30) Foreign Application Priority Data
Jul. 17, 2015 (DE) 102015213452.0

(51) Int. Cl. G01C 19/5762; G01C 19/5705

(52) U.S. Cl. CPC G01C 19/5762; G01C 19/5705

(57) ABSTRACT

A rotation rate sensor having a substrate having a principal extension plane and having a structure movable with respect to the substrate. The rotation rate sensor encompasses a first excitation unit for deflecting the structure out of an idle position substantially parallel to a first axis extending parallel to the principal extension plane, in such a way that the structure is excitable to oscillate at a first frequency with a motion component substantially in a direction parallel to the first axis, the rotation rate sensor encompassing a second excitation unit for deflecting the structure out of an idle position substantially parallel to a second axis extending parallel to the principal extension plane and extending perpendicularly to the first axis, in such a way that the structure is excitable to oscillate at a second frequency with a motion component substantially in a direction parallel to the second axis.

### FIELD

The present invention relates to a rotation rate sensor.

### BACKGROUND INFORMATION

Conventional rotation rate sensors usually encompass at least one structure that oscillates in a specified drive direction at a determined frequency and a determined amplitude.

In the conventional rotation rate sensors, several separate structures that can be caused to oscillate linearly are coupled to one another in order to enable the detection of rotation rates around different rotation axes. Each structure here is usually respectively responsible for detecting a rotation rate around a determined rotation axis. This means that for a multi-channel rotation rate sensor, i.e., for a rotation rate sensor that can measure several rotation rates around respective mutually perpendicular axes, the substrate area required for the micromechanical structure increases in accordance with the number of rotation axes around which rotation rates are to be detected.

### SUMMARY

An example rotation rate sensor according to the present invention and an example method according to the present invention for operating a rotation rate sensor may have the advantage that a multi-channel rotation rate sensor is made possible on a substrate area that is small relative to the existing art, since only a small substrate area, relative to the existing art, is needed in order to detect rotation rates around several rotation axes. The use of several structures in order to detect several rotation rates around several respective rotation axes is superfluous in this context. Instead, rotation rates around up to three mutually perpendicularly extending rotation axes are detected in one substrate region. In addition, a rotation rate sensor that is particularly robust with respect to the existing art is furnished. The advantageous effect is achieved by the fact that the rotation rate sensor according to the present invention, in contrast to the existing art, encompasses a second excitation unit for deflecting the structure out of an idle position, substantially parallel to a second axis extending parallel to the principal extension plane and extending perpendicularly to the first axis, in such a way that the structure is excitable to oscillate at a second frequency having a motion component substantially in a direction parallel to the second axis.

Advantageous embodiments and refinements of the present invention are described herein and are shown in the figures.

According to a preferred refinement of the present invention, provision is made that the rotation rate sensor has a first detection unit for detecting a force acting on the structure in a direction substantially parallel to a third axis extending substantially perpendicularly to the principal extension plane, at the first frequency and/or at the second frequency, as a result of a rotation rate of the rotation rate sensor around an axis parallel to the first axis and/or as a result of a rotation rate of the rotation rate sensor around an axis parallel to the second axis. What is thereby advantageously proposed is a multi-channel rotation rate sensor that, on a substrate area that is small relative to the existing art, detects rotation rates around more than one rotation axis in one substrate region. In addition, rotation rates around more than one rotation axis are advantageously detected with the aid of only one detection unit.

According to a preferred refinement of the present invention, provision is made that the rotation rate sensor encompasses a third excitation unit for deflecting the structure out of an idle position substantially parallel to a third axis extending perpendicularly to the principal extension plane, in such a way that the structure is excitable to oscillate at a third frequency with a motion component in a direction substantially parallel to the third axis. Excitation of the structure to oscillate at a third frequency advantageously makes possible the detection, on the basis of the third frequency, of two rotation rates around two respective axes that respectively extend substantially parallel to the first axis and parallel to the second axis.

According to a preferred refinement, provision is made that the rotation rate sensor has a second detection unit for detecting a force acting on the structure in a direction substantially parallel to the second axis, at the first frequency and/or at the third frequency, as a result of a rotation rate of the rotation rate sensor around an axis parallel to the first axis and/or as a result of a rotation rate of the rotation rate sensor around an axis parallel to the third axis. A multi-channel rotation rate sensor for measuring up to three rotation rates around axes respectively extending perpendicularly to one another is thereby advantageously furnished in a mechanically robust, inexpensive, and particular simple manner. It furthermore becomes advantageously possible for several measured signals to be respectively ascertainable for at least one rotation rate, and thus for fault-free operation of the rotation rate sensor to be checkable.

According to a preferred refinement, provision is made that the rotation rate sensor has a third detection unit for detecting a force acting on the structure in a direction substantially parallel to the first axis, at the second frequency and/or at the third frequency, as a result of a rotation rate of the rotation rate sensor around an axis parallel to the second axis and/or as a result of a rotation rate of the rotation rate sensor around an axis parallel to the third axis. It thereby becomes advantageously possible for several measured signals to be ascertainable for at least three rotation rates around three axes extending perpendicularly to one another, and thus for fault-free operation of a three-axis rotation rate sensor to be checkable.

According to a preferred refinement, provision is made that the rotation rate sensor encompasses at least one first suspension means and/or at least one second suspension means and/or at least one third suspension means for suspending the structure movably relative to the substrate, in such a way that the structure is excitable to oscillate at a first frequency with a motion component substantially in a direction parallel to the first axis and/or that the structure is excitable to oscillate at a second frequency with a motion component substantially in a direction parallel to the second axis and/or that the structure is excitable to oscillate at a third frequency with a motion component substantially in a direction parallel to the third axis. This advantageously allows the structure to be suspended movably relative to the substrate so as to make possible the oscillation behavior of the rotation rate sensor according to the present invention.

According to a preferred refinement of the present invention, provision is made that the first detection unit encompasses at least one first electrode, the first electrode being embodied in substantially plate-shaped fashion, the first electrode extending substantially parallel to a plane encompassing the first axis and the second axis, the second detection unit encompassing at least one second electrode, the second electrode being embodied in substantially plate-shaped fashion, the second electrode extending substantially parallel to a plane encompassing the first axis and the third axis, the third detection unit encompassing at least one third electrode, the third electrode being embodied in substantially plate-shaped fashion, the third electrode extending substantially parallel to a plane encompassing the second axis and the third axis. What is advantageously made possible thereby is that the forces acting on the structure can be sensed capacitively.

According to a preferred embodiment, provision is made that the rotation rate sensor encompasses a further structure movable with respect to the substrate, the further structure being excitable to oscillate in counter-phase with respect to the structure at the first frequency with a motion component substantially in a direction parallel to the first axis and/or at the second frequency with a motion component substantially in a direction parallel to the second axis and/or at the third frequency with a motion component substantially in a direction parallel to the third axis. Preferably the structure and the further structure are mechanically coupled to one another. What is advantageously made possible thereby is that rotation rates around one rotation axis and/or two mutually perpendicular rotation axes and/or three mutually perpendicular rotation axes can be detected in one substrate region on a substrate area that is small relative to the existing art, including reduction of the force outcoupling of the oscillating masses and in a manner that is robust with respect to linear accelerations.

According to a preferred refinement of the present invention, provision is made that the rotation rate sensor has a further first detection unit for detecting a force acting on the further structure in a direction substantially parallel to the third axis, at the first frequency and/or at the second frequency, as a result of a rotation rate of the rotation rate sensor around an axis parallel to the first axis and/or as a result of a rotation rate of the rotation rate sensor around an axis parallel to the second axis, the rotation rate sensor having a further second detection unit for detecting a force acting on the further structure in a direction substantially parallel to the second axis, at the first frequency and/or at the third frequency, as a result of a rotation rate of the rotation rate sensor around an axis parallel to the first axis and/or as a result of a rotation rate of the rotation rate sensor around an axis parallel to the third axis, the rotation rate sensor having a further third detection unit for detecting a force acting on the further structure in a direction substantially parallel to the first axis, at the second frequency and/or at the third frequency, as a result of a rotation rate of the rotation rate sensor around an axis parallel to the second axis and/or as a result of a rotation rate of the rotation rate sensor around an axis parallel to the third axis. What is thereby made possible is that several measured signals for three rotation rates around three mutually perpendicularly extending axes are ascertainable, and fault-free operation of a three-axis rotation rate sensor is checkable, with reduced force outcoupling of the oscillating masses and in a manner that is robust with respect to linear accelerations.

A further subject of the present invention is a method for operating a rotation rate sensor according to the present invention,
in a first method step, the structure and/or the further structure being deflected out of an idle position of the structure and/or out of an idle position of the further structure, with the aid of at least one drive signal, in such a way that the structure and/or the further structure is/are excited to oscillate, or to oscillate substantially in counter-phase to one another, at the first frequency with a motion component in a direction parallel to the first axis and/or at the second frequency with a motion component in a direction parallel to the second axis and/or at the third frequency with a motion component in a direction parallel to the third axis,
in a second method step, at least one detection signal being detected with the aid of the first detection unit and/or the second detection unit and/or the third detection unit, and/or with the aid of the further first detection unit and/or the further second detection unit and/or the further third detection unit,
in a third method step, the at least one detection signal being processed with the aid of synchronous demodulation at the first frequency and/or at the second frequency and/or at the third frequency, and with the aid of low-pass filtration,
in a fourth method step, at least one rotation rate associatable with the first frequency and/or with the second frequency and/or with the third frequency being ascertained from the at least one processed detection signal. What is thereby advantageously made possible is that several measured signals for rotation rates around one rotation axis and/or two mutually perpendicular rotation axes and/or three mutually perpendicular rotation axes can be ascertained in one substrate region on a substrate area that is small relative to the existing art, and that fault-free operation of a three-axis rotation rate sensor is thereby checkable.

### BRIEF DESCRIPTION OF THE DRAWINGS

FIG. 1 schematically depicts a rotation rate sensor in accordance with an exemplifying embodiment of the present invention.

### DETAILED DESCRIPTION OF EXAMPLE EMBODIMENTS

Identical parts are labeled with identical reference characters and are each therefore, generally, also mentioned only once.

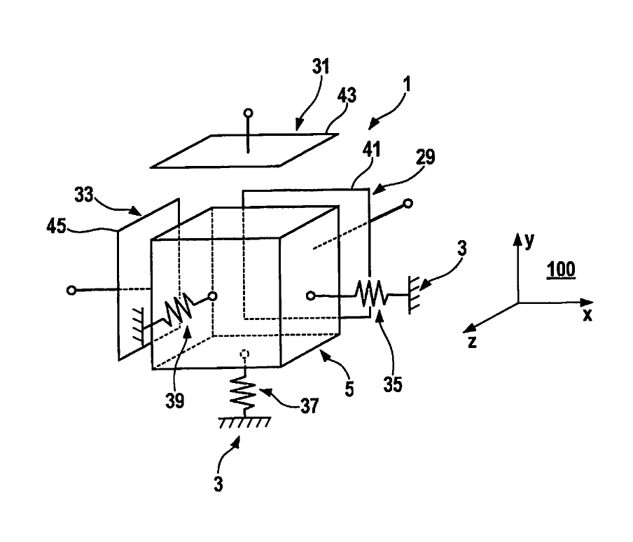

FIG. 1 schematically depicts a rotation rate sensor 1 in accordance with an exemplifying embodiment of the present invention, rotation rate sensor 1 encompassing a substrate 3, indicated with the aid of substrate attachments, having a principal extension plane 100 and having a structure 5 movable with respect to substrate 3. A first excitation unit (not depicted) is provided in order to deflect structure 5, so that structure 5 is excitable to oscillate at a first frequency out of an idle position depicted in FIG. 1 with a motion component in a direction parallel to first axis X. Rotation rate sensor 1 depicted in FIG. 1 furthermore encompasses a second excitation unit (not depicted) for exciting structure 5 to oscillate at a second frequency out of the idle position with a motion component in a direction parallel to second axis Y. Rotation rate sensor 1 depicted in FIG. 1 furthermore encompasses a third excitation unit (not depicted) for exciting structure 5 to oscillate at a third frequency with a motion component in a direction parallel to third direction Z. Structure 5 is preferably excited via capacitive forces. Also preferably, the oscillation amplitudes in the three spatial directions are measured via capacitive measurement sensors, and a constant oscillation amplitude is established with the aid of an electronic system, preferably automatic gain control (AGC) and phased-lock loop (PLL). Preferably, structure 5 is excited via capacitive forces to oscillate at its resonant frequencies in the three spatial directions. For example, the oscillation amplitude in the three spatial directions is determined in this context via capacitive measurement sensors.

In order for an above-described excitation of structure 5 to be possible, rotation rate sensor 1 depicted in FIG. 1 encompasses a first suspension component 35, a second suspension component 37, and a third suspension component 39. Preferably the suspension components are springs.

In order to detect a force acting on structure 5, at the first frequency and/or at the second frequency and/or at the third frequency, as a result of a rotation rate of rotation rate sensor 1 around an axis parallel to first axis X and/or around an axis parallel to second axis Y and/or around an axis parallel to third axis Z, rotation rate sensor 1 depicted in FIG. 1 furthermore encompasses a first detection unit 29, a second detection unit 31, and a third detection unit 33. First detection unit 29 encompasses a first electrode 41, second detection unit 31 a second electrode 43, and third detection unit 33 a third electrode 45.

For example, a rotation rate of rotation rate sensor 1 around an axis parallel to first axis X results in Coriolis deflections of structure 5 in a direction parallel to second axis Y at the third frequency, and in Coriolis deflections of structure 5 in a direction parallel to third axis Z at the second frequency. For example, a rotation rate of rotation rate sensor 1 around an axis parallel to first axis X results in Coriolis accelerations acting on structure 5 in a direction parallel to second axis Y at the third frequency and in a direction parallel to third axis Z at the second frequency.

A rotation rate of rotation rate sensor 1 around an axis parallel to second axis Y and a rotation rate of rotation rate sensor 1 around an axis parallel to third axis Z results, for example, in corresponding Coriolis deflections of structure 5, and in corresponding Coriolis accelerations acting on structure 5, in the corresponding directions at the corresponding frequencies. The Coriolis deflections or Coriolis accelerations are sensed, for example, capacitively, demodulated at the respective frequencies, and low-pass filtered. The signal thereby processed is an indication of the applied rotation rates. The detected Coriolis deflections or Coriolis accelerations have a different frequency from the signal of the excitation oscillation in that direction. The Coriolis forces and the corresponding rotation rates can be detected by demodulation at the corresponding resonant frequencies.

The rotation rate sensor depicted in FIG. 1 thus offers the advantage that the same mass can be used to measure rotation rates in different spatial directions. A further advantage is that enhanced robustness in the context of measurement of a rotation rate is furnished thanks to evaluation of the Coriolis accelerations that have been ascertained at two frequencies. If no errors are present, the two ascertained rotation rates must indicate identical values.

Rotation rate sensor 1 depicted in FIG. 1 encompasses only structure 5. Provision is made in particular, however, for rotation rate sensor 1 additionally to encompass a further structure, preferably coupled mechanically to structure 5. The further structure is excited to oscillate in counter-phase with respect to structure 5 at the first frequency, the second frequency, and the third frequency, in each case with a motion component in the respective directions parallel to first axis X, parallel to second axis Y, and parallel to third axis Z. The further excitation units and further detection units provided for the further structure correspond substantially to the excitation units and detection units provided for structure 5. This makes possible a reduction in the force outcoupling of the oscillating masses, and in an enhancement in robustness with respect to linear accelerations.

1-10. (canceled)

11. A rotation rate sensor, comprising:
a substrate having a principal extension plane;
a structure movable with respect to the substrate;
a first excitation unit for deflecting the structure out of an idle position parallel to a first axis extending parallel to the principal extension plane, in such a way that the structure is excitable to oscillate at a first frequency with a motion component substantially in a direction parallel to the first axis;
a second excitation unit for deflecting the structure out of an idle position parallel to a second axis extending parallel to the principal extension plane and extending perpendicularly to the first axis, in such a way that the structure is excitable to oscillate at a second frequency with a motion component in a direction parallel to the second axis.

12. The rotation rate sensor as recited in claim 11, further comprising:
a first detection unit for detecting a force acting on the structure in a direction parallel to a third axis extending perpendicularly to the principal extension plane, at least one of: (i) at the first frequency, and (ii) at the second frequency, at least one of: (i) as a result of a rotation rate of the rotation rate sensor around an axis parallel to the first axis, and (ii) as a result of a rotation rate of the rotation rate sensor around an axis parallel to the second axis.

13. The rotation rate sensor as recited in claim 12, further comprising:
a third excitation unit for deflecting the structure out of an idle position parallel to a third axis extending perpendicularly to the principal extension plane, in such a way that the structure is excitable to oscillate at a third frequency with a motion component in a direction parallel to the third axis.

14. The rotation rate sensor as recited in claim 13, further comprising:
a second detection unit for detecting a force acting on the structure in a direction parallel to the second axis, at least one of: (i) at the first frequency, and (ii) at the third frequency, at least one of: (i) as a result of a rotation rate of the rotation rate sensor around an axis parallel to the first axis, and (ii) as a result of a rotation rate of the rotation rate sensor around an axis parallel to the third axis.

15. The rotation rate sensor as recited in claim 14, wherein the rotation rate sensor has a third detection unit for detecting a force acting on the structure in a direction parallel to the first axis, one of: (i) at the second frequency, and (ii) at the third frequency, at least one of: (i) as a result of a rotation rate of the rotation rate sensor around an axis parallel to the second axis, and (ii) as a result of a rotation rate of the rotation rate sensor around an axis parallel to the third axis.

16. The rotation rate sensor as recited in claim 13, wherein the rotation rate sensor encompasses at least one of: (i) at least one first suspension component, (ii) at least one second suspension component, and (iii) at least one third suspension component, for suspending the structure movably relative to the substrate, in such a way that at least one of: (i) the structure is excitable to oscillate at the first frequency with a motion component substantially in a direction parallel to the first axis, (ii) the structure is excitable to oscillate at the second frequency with a motion component substantially in a direction parallel to the second axis, and (iii) the structure is excitable to oscillate at the third frequency with a motion component substantially in a direction parallel to the third axis.

17. The rotation rate sensor as recited in claim 15, wherein the first detection unit encompasses at least one first electrode, the first electrode being embodied in substantially plate-shaped fashion, the first electrode extending parallel to a plane encompassing the first axis and the second axis, the second detection unit encompassing at least one second electrode, the second electrode being embodied in plate-shaped fashion, the second electrode extending substantially parallel to a plane encompassing the first axis and the third axis, the third detection unit encompassing at least one third electrode, the third electrode being embodied in plate-shaped fashion, the third electrode extending substantially parallel to a plane encompassing the second axis and the third axis.

18. The rotation rate sensor as recited in claim 13, wherein the rotation rate sensor encompasses a further structure movable with respect to the substrate, the further structure being excitable to oscillate in counter-phase with respect to the structure at least one of: (i) at the first frequency with a motion component in a direction parallel to the first axis, and (ii) at the second frequency with a motion component in a direction parallel to the second axis, and (iii) at the third frequency with a motion component substantially in a direction parallel to the third axis.

19. The rotation rate sensor as recited in claim 18, wherein the rotation rate sensor has a further first detection unit for detecting a force acting on the further structure in a direction substantially parallel to the third axis, at least one of: (i) at the first frequency, and (ii) at the second frequency, at least one of: (i) as a result of a rotation rate of the rotation rate sensor around an axis parallel to the first axis, and (ii) as a result of a rotation rate of the rotation rate sensor around an axis parallel to the second axis, the rotation rate sensor having a further second detection unit for detecting a force acting on the further structure in a direction parallel to the second axis, at least one of: (i) at the first frequency, and (ii) at the third frequency, at least one of: (i) as a result of a rotation rate of the rotation rate sensor around an axis parallel to the first axis, and (ii) as a result of a rotation rate of the rotation rate sensor around an axis parallel to the third axis, the rotation rate sensor having a further third detection unit for detecting a force acting on the further structure in a direction parallel to the first axis, at least one of: (i) at the second frequency, and (ii) at the third frequency, at least one of: (i) as a result of a rotation rate of the rotation rate sensor around an axis parallel to the second axis, and (ii) as a result of a rotation rate of the rotation rate sensor around an axis parallel to the third axis.

20. A method for operating a rotation rate sensor, the rotation rate sensor including a substrate having a principal extension plane, a structure movable with respect to the substrate, a first excitation unit for deflecting the structure out of an idle position parallel to a first axis extending parallel to the principal extension plane, in such a way that the structure is excitable to oscillate at a first frequency with a motion component substantially in a direction parallel to the first axis, a second excitation unit for deflecting the structure out of an idle position parallel to a second axis extending parallel to the principal extension plane and extending perpendicularly to the first axis, in such a way that the structure is excitable to oscillate at a second frequency with a motion component in a direction parallel to the second axis, the method comprising:
deflecting the structure out of the idle position of the structure, with the aid of at least one drive signal, in such a way that the structure is excited to oscillate at the first frequency with a motion component in a direction parallel to the first axis;
detecting at least one detection signal being detected with the aid of the first detection unit;
processing the at least one detection signal with the aid of synchronous demodulation at the first frequency, and with the aid of low-pass filtration; and
ascertaining at least one rotation rate associatable with the first frequency from the at least one processed detection signal.
